(19) United States
(12) Patent Application Publication
(10) Pub. No.: US 2026/0222403 A1
(43) Pub. Date: Jul. 30, 2026

(54) FACE AUTHENTICATION METHODS, APPARATUSES, AND SYSTEMS

(71) Applicant: Alipay (Hangzhou) Information Technology Co., Ltd., Hangzhou (CN)

(72) Inventor: Shangcheng SHI, Hangzhou (CN)

(21) Appl. No.: 19/157,358

(22) PCT Filed: Apr. 3, 2024
(86) PCT No.: PCT/CN2024/085939

§ 371 Date: Aug. 17, 2025

(30) Foreign Application Priority Data
Apr. 6, 2023 (CN) 202310378160.9

(51) Int. Cl. H04L 9/40

(52) U.S. Cl. CPC H04L 63/0861

(57) ABSTRACT

Embodiments of this specification discloses a face authentication method, including: receiving a face authentication initialization request that is sent by an authentication requester and that includes a temporary identity credential, returning a session identifier to the authentication requester, and establishing a mapping relationship between the temporary identity credential and the session identifier; receiving a face authentication request initiated by the authentication requester based on the session identifier, and obtaining a corresponding face authentication result; receiving an authentication result query request sent by the authentication requester, where the query request includes the session identifier and the temporary identity credential; and verifying, based on the mapping relationship, whether the session identifier matches the temporary identity credential, and returning the face authentication result corresponding to the session identifier when the session identifier matches the temporary identity credential. Correspondingly, the embodiments of this specification disclose a face authentication apparatus and system.

### TECHNICAL FIELD

Embodiments of this specification relate to computer technologies, and in particular, to face authentication methods, apparatuses, and systems.

### BACKGROUND

Currently, a large mobile application (referred to as a vendor for short) provides various third-party services to external merchant Apps (including a small program, an H5, and a Native App), including a third-party face authentication service. Due to complexity of a related network protocol, an external merchant developer may incorrectly access a service provided by the vendor, resulting in a security risk. For example, once a merchant server incorrectly uses a user credential delivered by the vendor in service deployment, a logical vulnerability may be introduced. Subsequently, an attacker can tamper with mobile client protocol communication to bypass face authentication in the merchant App to obtain benefits of a victim. Currently, a mainstream three-party face protocol does not have any fault tolerance, and therefore cannot provide a security guarantee for an authentication service. In addition, the vendor also lacks a mature security detection mechanism to ensure security of an output face service of the vendor. Once there is a vulnerability in logic of the merchant App, an attacker can easily bypass face authentication of the vendor, and the vendor cannot ensure security of an authentication process even if a reliable authentication service is provided.

In view of this, it is expected to obtain a new face authentication solution to improve security of a three-party face authentication service.

### SUMMARY

One objective of embodiments of this specification is to provide a face authentication method. In the method, an association of a user identity is detected to prevent a potential client traffic tampering attack, and identify, in a timely manner, a risk of skipping a face detection step by an attacker to steal user information, thereby increasing a fault tolerance rate and a security level of a face authentication service.

Based on the above-mentioned objective of this specification, an embodiment of this specification provides a face authentication method, applied to an authentication executor. The method includes: receiving a face authentication initialization request sent by an authentication requester, where the initialization request includes a temporary identity credential, returning a session identifier to the authentication requester, and establishing a mapping relationship between the temporary identity credential and the session identifier; receiving a face authentication request initiated by the authentication requester based on the session identifier, and obtaining a face authentication result corresponding to the session identifier; receiving an authentication result query request sent by the authentication requester, where the query request includes the session identifier and the temporary identity credential; and verifying, based on the mapping relationship, whether the session identifier matches the temporary identity credential, and returning the face authentication result corresponding to the session identifier when the session identifier matches the temporary identity credential.

In this embodiment of this specification, the mapping relationship between the temporary identity credential and the session identifier is established and detected to actively detect user identity security, thereby increasing security and a fault tolerance rate of a face authentication service while reducing access costs of an authentication requester.

Further, in some implementations, the step of receiving a face authentication request initiated by the authentication requester based on the session identifier, and obtaining a face authentication result corresponding to the session identifier includes: receiving a face authentication link initiated by the authentication requester based on the session identifier, and collecting a face image by using the face authentication link; and performing face authentication based on the collected face image to obtain the face authentication result corresponding to the session identifier.

Further, in some implementations, the temporary identity credential is generated by the authentication requester based on trusted identity information of a to-be-authenticated user.

Still further, in some implementations, the step of obtaining a face authentication result corresponding to the session identifier includes: receiving the face authentication request initiated by the authentication requester based on the session identifier and the temporary identity credential corresponding to the session identifier; and obtaining the trusted identity information of the to-be-authenticated user based on the temporary identity credential, and querying a face information database based on the trusted identity information, to obtain the face authentication result corresponding to the session identifier.

Further, in some implementations, the step of receiving a face authentication request initiated by the authentication requester based on the session identifier, obtaining a face authentication result corresponding to the session identifier, and receiving an authentication result query request sent by the authentication requester includes: obtaining the face authentication result corresponding to the session identifier, and sending an authentication receipt to the authentication requester, where the authentication receipt includes the session identifier, and the authentication receipt is used to indicate that face authentication corresponding to the session identifier is completed; and when the authentication requester verifies that the session identifier is in correspondence with the temporary identity credential, receiving the authentication result query request sent by the authentication requester.

Based on the above-mentioned objective of this specification, an embodiment of this specification further provides a face authentication method, applied to an authentication requester. The method includes: sending a face authentication initialization request to an authentication executor, where the initialization request includes a temporary identity credential, and receiving a session identifier that is generated by the authentication executor based on the initialization request; initiating a face authentication request based on the session identifier, and sending the face authentication request to the authentication executor, so that the authentication executor performs face authentication corresponding to the session identifier and obtains a face authentication result; sending an authentication result query request to the authentication executor, where the query request includes the session identifier and the temporary identity credential; and when the authentication executor verifies that the session identifier matches the temporary identity credential, receiving the face authentication result that is sent by the authentication executor and that corresponds to the session identifier.

In this embodiment of this specification, the authentication executor with a stronger technical capability and stronger security helps maintain and detect a mapping relationship between the temporary identity credential and the session identifier, thereby increasing security and a fault tolerance rate while reducing upgrade costs of a face authentication service.

Further, in some implementations, the step of initiating a face authentication request based on the session identifier, and sending the face authentication request to the authentication executor, so that the authentication executor performs face authentication corresponding to the session identifier and obtains a face authentication result includes: initiating a face authentication link based on the session identifier, and sending the face authentication link to the authentication executor, so that the authentication executor collects a face image by using the face authentication link, and performs face authentication based on the collected face image to obtain the face authentication result corresponding to the session identifier.

Further, in some implementations, before the sending a face authentication initialization request to an authentication executor, the method further includes: generating the face authentication initialization request, and generating the temporary identity credential based on trusted identity information of a to-be-authenticated user.

Still further, in some implementations, after the generating the face authentication initialization request, and generating the temporary identity credential based on trusted identity information of a to-be-authenticated user, the method further includes: storing the session identifier and the temporary identity credential in correspondence; receiving an authentication receipt sent by the authentication executor, where the authentication receipt includes the session identifier, and the authentication receipt is used to indicate that face authentication corresponding to the session identifier is completed; and performing matching verification based on the session identifier in the authentication receipt and the temporary identity credential, and sending the authentication result query request to the authentication executor when the session identifier is in correspondence with the temporary identity credential.

Another objective of embodiments of this specification is to provide a face authentication apparatus. The apparatus detects an association of a user identity to prevent a potential client traffic tampering attack, and identify, in a timely manner, a risk of skipping a face detection step by an attacker to steal user information, thereby increasing a fault tolerance rate and a security level of a face authentication service.

Based on the above-mentioned objective, an embodiment of this specification provides a face authentication apparatus, including a session creation module, an authentication module, a query module, and a verification module. The session creation module is configured to:
receive a face authentication initialization request sent by an authentication requester, where the initialization request includes a temporary identity credential, return a session identifier to the authentication requester, and establish a mapping relationship between the temporary identity credential and the session identifier. The authentication module is configured to: receive a face authentication request initiated by the authentication requester based on the session identifier, and obtain a face authentication result corresponding to the session identifier. The query module is configured to receive an authentication result query request sent by the authentication requester, where the query request includes the session identifier and the temporary identity credential. The verification module is configured to: verify, based on the mapping relationship, whether the session identifier matches the temporary identity credential, and return the face authentication result corresponding to the session identifier when the session identifier matches the temporary identity credential.

Still another objective of embodiments of this specification is to provide a face authentication system. The system detects an association of a user identity to prevent a potential client traffic tampering attack, and identify, in a timely manner, a risk of skipping a face detection step by an attacker to steal user information, thereby increasing a fault tolerance rate and a security level of a face authentication service.

Based on the above-mentioned objective, an embodiment of this specification further provides a face authentication system, including a requesting end and an execution end. The requesting end sends a face authentication initialization request to the execution end, where the initialization request includes a temporary identity credential. The execution end returns a session identifier to the requesting end, and establishes a mapping relationship between the temporary identity credential and the session identifier. The requesting end initiates a face authentication request based on the session identifier, and sends the face authentication request to the execution end, and the execution end obtains a face authentication result corresponding to the session identifier. The requesting end sends an authentication result query request to the execution end, where the query request includes the session identifier and the temporary identity credential. The execution end verifies, based on the mapping relationship, whether the session identifier matches the temporary identity credential, and returns the face authentication result corresponding to the session identifier when the session identifier matches the temporary identity credential.

Further, in some implementations, the requesting end initiates a face authentication link based on the session identifier, and sends the face authentication link to the execution end, so that the execution end collects a face image by using the face authentication link, and performs face authentication based on the collected face image to obtain the face authentication result corresponding to the session identifier.

Further, in some implementations, the requesting end is further configured to: generate the face authentication initialization request, generate the temporary identity credential based on trusted identity information of a to-be-authenticated user, and attach the temporary identity credential to the face authentication initialization request to be sent to the execution end.

Still further, in some implementations, the requesting end is further configured to: initiate the face authentication request based on the session identifier, and send the face authentication request and the temporary identity credential corresponding to the session identifier to the execution end, so that the execution end obtains the trusted identity information of the to-be-authenticated user based on the temporary identity credential, and queries a face information database based on the trusted identity information, to obtain the face authentication result corresponding to the session identifier.

Further, in some implementations, the requesting end is further configured to store the session identifier and the temporary identity credential in correspondence; the execution end obtains the face authentication result corresponding to the session identifier, and sends an authentication receipt to the requesting end, where the authentication receipt includes the session identifier, and the authentication receipt is used to indicate that face authentication corresponding to the session identifier is completed; and the requesting end performs matching verification based on the session identifier in the authentication receipt and the temporary identity credential, and sends the authentication result query request to the execution end when the session identifier is in correspondence with the temporary identity credential.

Still another object of embodiments of this specification is to provide a computer-readable storage medium. The storage medium stores a computer program, and when the computer program is executed by a processor, the steps in the above-mentioned face authentication method are implemented.

Still another object of embodiments of this specification is to provide an electronic device, including a memory, a processor, and a computer program that is stored in the memory and that is capable of running on the processor. When the processor executes the program, the steps in the above-mentioned face authentication method are implemented.

According to the face authentication methods, apparatuses, and systems described in the embodiments of this specification, the mapping relationship between the temporary identity credential and the session identifier is established and detected to actively detect user identity security, to prevent a potential client traffic tampering attack, and identify, in a timely manner, a risk of skipping a face detection step by an attacker to steal user information, while reducing access costs of the authentication requester, thereby increasing a fault tolerance rate and a security level of a face authentication service.

### BRIEF DESCRIPTION OF DRAWINGS

FIG. 1 is an example diagram illustrating an application scenario of a face authentication method in an implementation, according to an embodiment of this specification;

FIG. 2 is an example schematic diagram illustrating steps of a current face authentication method in an implementation;

FIG. 3 is an example schematic diagram illustrating steps of stealing user information by an attacker by using a current face authentication method;

FIG. 4 shows an example of steps of a face authentication method that are performed in an implementation, according to an embodiment of this specification;

FIG. 5 is an example schematic flowchart illustrating a face authentication method in an implementation, according to an embodiment of this specification;

FIG. 6 is an example schematic flowchart illustrating a face authentication method in another implementation, according to an embodiment of this specification;

FIG. 7 is an example schematic structural diagram illustrating a face authentication apparatus in an implementation, according to an embodiment of this specification; and

FIG. 8 is an example schematic structural diagram illustrating a face authentication system in an implementation, according to an embodiment of this specification.

### DESCRIPTION OF EMBODIMENTS

The following further describes in detail the face authentication methods, apparatuses, and systems described in the embodiments of this specification with reference to the accompanying drawings and specific embodiments of this specification. However, the detailed description does not constitute a limitation on the embodiments of this specification.

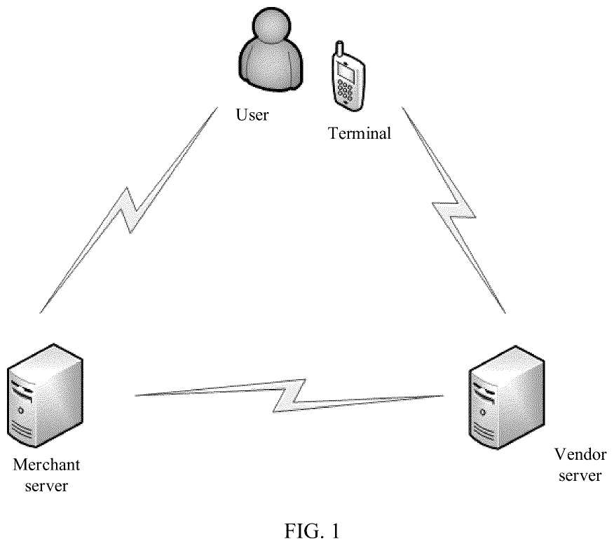

FIG. 1 is an example diagram illustrating an application scenario of a face authentication method in an implementation, according to an embodiment of this specification.

Currently, some large mobile applications serve as vendors to provide various three-party services for external merchant Apps, including a three-party face authentication service. The embodiments of this specification can be applied to various usage scenarios in which account security requirements are relatively high, for example, a scenario involving a fund transaction or a scenario in which face authentication is required to log in to an account. In these usage scenarios, there are still some operations with a relatively high risk. For example, for a fund transaction platform, performing a large-amount fund transaction, changing a payment password, and changing a mobile number bound to an account number are operations that pose a serious risk to account security. Therefore, the platform has strict security control over such operations.

As shown in FIG. 1, in some embodiments, a terminal can be a mobile device, a merchant App serves as a party that requires face authentication, and a vendor App serves as a party that performs face authentication. Both the merchant App and the vendor App are installed on a terminal device. When the merchant App and the vendor App respectively communicate with servers corresponding to the merchant App and the vendor App, communication is also performed between the merchant App and vendor App, and between a merchant server and a vendor server. First, a user initiates a payment or login operation on the merchant App on the terminal. The merchant server receives a face authentication initialization request sent by the merchant App, generates a temporary identity credential, sends the face authentication initialization request to the vendor server, and receives a returned session identifier. The merchant server initiates a face authentication request based on the session identifier, and transmits the face authentication request by using the terminal, so that the user completes a face scanning operation on the terminal. A face authentication result generated on the vendor server is returned to the merchant server by using the terminal. Then, the merchant server directly initiates an authentication result query request to the vendor server based on the temporary identity credential and the session identifier, receives a returned authentication result, and then returns the authentication result to the merchant App on the terminal to complete face authentication.

It is worthwhile to note that, each block in a block diagram or flowchart and a combination of blocks in a block diagram or flowchart in the accompanying drawings can be implemented by using a dedicated hardware-based system that performs a specified function or operation, or can be implemented by using a combination of dedicated hardware and a computer instruction. In addition, the modules described in the embodiments of this specification can be implemented by software or hardware.

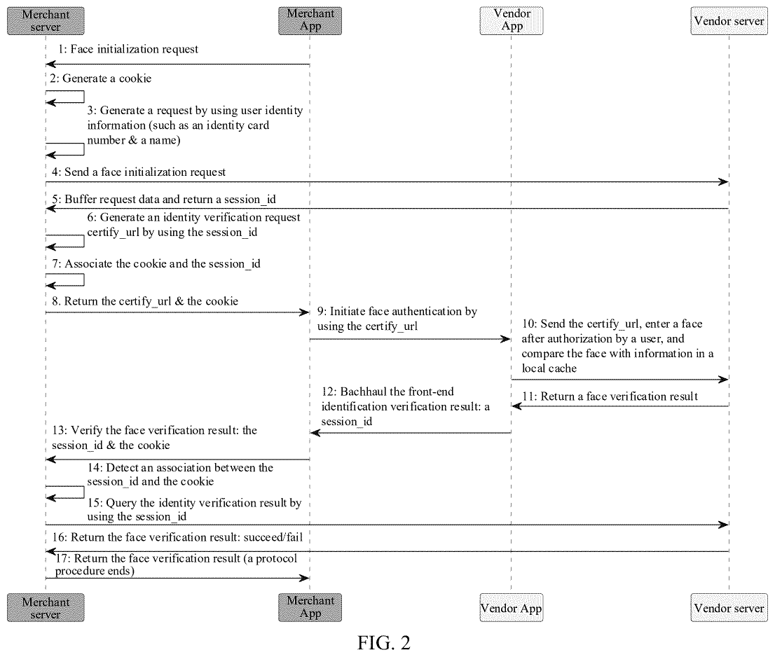

FIG. 2 is an example schematic diagram illustrating steps of a current face authentication method in an implementation.

As shown in FIG. 2, a user initiates, on a merchant App, an operation that requires face authentication, such as payment or account login, and sends a face authentication initialization request to a merchant server. The merchant server generates a cookie to mark a temporary identity of the user in the merchant App, generates a face authentication initialization request based on identity information such as an identity card of the user, and sends the face authentication initialization request to a vendor server to apply for obtaining a session identifier session_id to mark user identity information in a subsequent face authentication result. In the merchant server, a face authentication request is generated based on the session_id, a certify_url can be sent by using a link, and the cookie and the session_id are associated and then are transmitted to a vendor APP together with the face authentication request by using the merchant App. The vendor App guides the user to complete a face scanning operation, sends data obtained through the face scanning to the vendor server to be compared with data in a local cache to obtain user identity information corresponding to a face, marks the user identity information with the session_id, and returns the face authentication result to the merchant server. The merchant server verifies the face authentication result and the association between the cookie and the session_id, reconfirms the face authentication result to the vendor server, where an obtained result is that “succeed” or “fail”, and displays the result in the merchant App.

A three-party face authentication service is intended to enable the merchant server to confirm that a target user has succeeded in face authentication provided by a vendor. Therefore, after receiving the face authentication result for the first time, the merchant server reconfirms, to the vendor server, that the user actually completes the face scanning operation.

In the current face authentication method, there are two types of user identities, where the cookie is maintained by a merchant, and the session_id is maintained by a vendor, and a mapping relationship between the two is maintained by the merchant, to ensure that a user who completes a face scanning operation is exactly a user that needs to undergo face authentication in the merchant App. However, due to lack of security awareness and a need to reduce costs, some merchant developers often ignore a logical operation of detecting the mapping relationship between the cookie and the session_id. Consequently, user identity information and account information are at risk of being attacked.

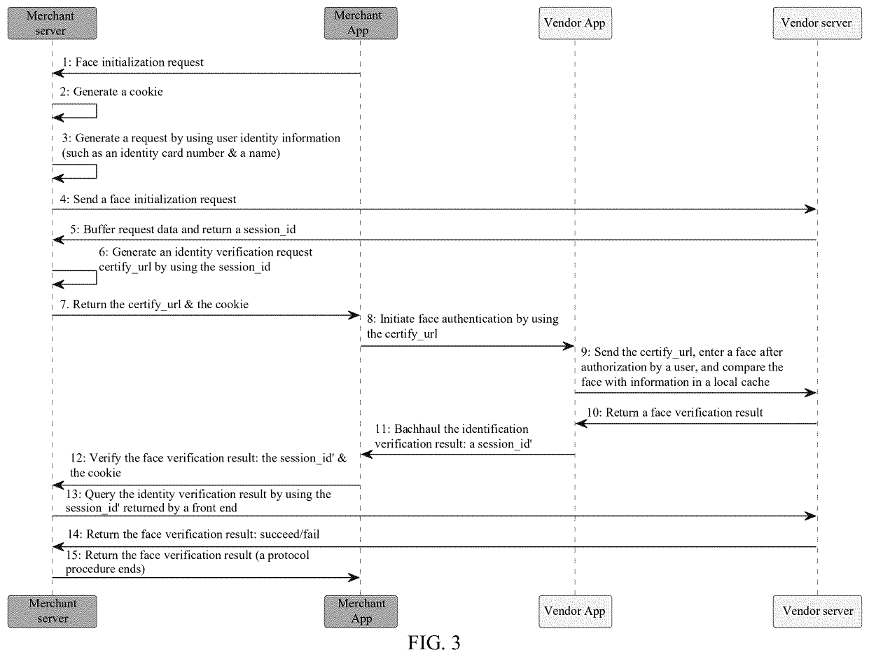

FIG. 3 is an example schematic diagram illustrating steps of stealing user information by an attacker by using a current face authentication method.

As shown in FIG. 3, after the merchant server applies to the vendor server for the session_id, the merchant does not associate the cookie with the session_id, which causes a logical vulnerability. As a result, the association between the cookie and the session_id is not detected when the face authentication result is received from the vendor server. As such, before the merchant server receives the face authentication result, the attacker can replace the user identity information session_id in the result with a session_id obtained by the attacker through face scanning on the same vendor App, to skip a face authentication process, and directly threaten an account of an injured user. An authentication result returned after the merchant server initiates an authentication result query request does not include the identity information of the user. Therefore, if the merchant server blindly trusts the session_id returned by the merchant App without maintaining the mapping relationship between the cookie and the session_id, the merchant server is highly vulnerable to an injected attack of the attacker. In this case, even if a reliable authentication service is provided, the vendor server cannot actively help detect such a risk and ensure security of an authentication process.

In view of this, it is expected to obtain a more secure face authentication solution. A mapping relationship between a temporary identity credential and a session identifier is established and detected to actively detect user identity security, thereby increasing security and fault tolerance rate of a face authentication service.

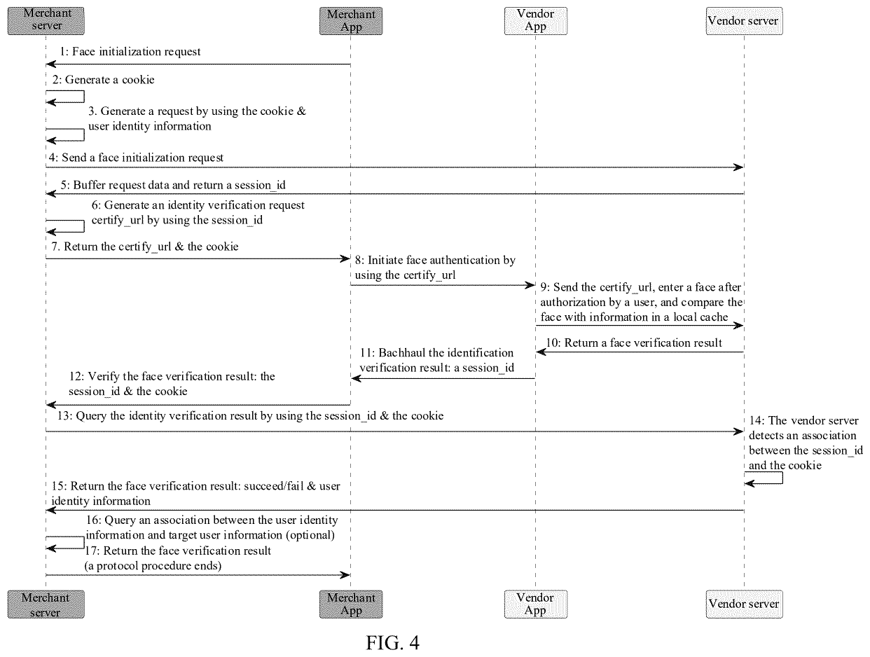

FIG. 4 shows an example of steps of a face authentication method that are performed in an implementation, according to an embodiment of this specification.

As shown in FIG. 4, in a face authentication initialization request sent by a merchant server to a vendor server, a temporary identity credential cookie of a user requesting face authentication is attached, where the temporary identity credential cookie can include a user_id such as an identity card or a passport number of the user. A back-end server of a merchant receives the face authentication initialization request, generates a session_id used to mark user identity information obtained by face authentication in the merchant, where the session_id is alternatively referred to as a session identifier, and establishes a mapping relationship between the temporary identity credential cookie and the session identifier session_id, and stores the mapping relationship in a local cache of the merchant. Further, when reconfirming a face authentication result to the vendor server, the merchant server re-attaches the cookie to an authentication result query request. After receiving the cookie, the vendor server detects an association between the cookie and the session_id through comparison with a mapping relationship that is between the cookie and the session_id and that is pre-stored in the local cache, and returns a corresponding face authentication result to the merchant server. In addition, the vendor server further returns corresponding user identity information for secondary verification by the merchant server.

In this implementation, the vendor server with a stronger technical capability and stronger security can help the external merchant maintain and detect an association between a temporary user identity in the merchant App and a user identity obtained through current face authentication in the vendor, to automatically identify a risk of injected attack type and prevent a potential client traffic tampering attack. In addition, identity information of a corresponding user is automatically added to a face result query response finally returned by the vendor server, to provide a capability of self-query by the merchant server.

A mobile end is mainly used as an example in the following embodiments to facilitate solution description. However, the methods and systems provided in the embodiments of this specification are not limited to the mobile end, and the following embodiments are not used to limit a usage scenario of the solutions.

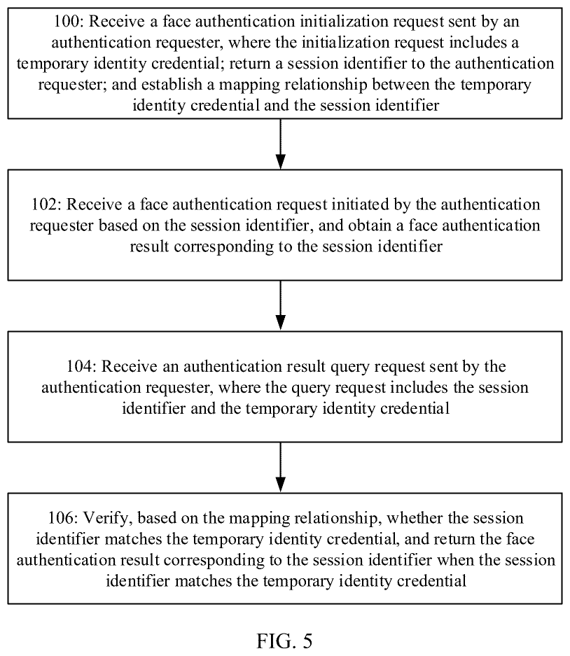

In an embodiment of this specification, a face authentication method is provided. FIG. 5 is an example schematic flowchart illustrating a face authentication method in an implementation, according to an embodiment of this specification.

As shown in FIG. 5, the method is applied to an authentication executor, and the method includes step 100 to step 106.

100: Receive a face authentication initialization request sent by an authentication requester, where the initialization request includes a temporary identity credential; return a session identifier to the authentication requester; and establish a mapping relationship between the temporary identity credential and the session identifier.

The authentication requester is usually an external merchant, including a merchant App and a corresponding merchant server, where the merchant App can be a small program, a mobile-end web page, or a local App. In a case of limited technologies or costs, some merchant developers usually select three-party services provided by some large mobile applications (or referred to as vendors), which not only can reduce operation and maintenance costs and improve service efficiency, but also can make up for gaps in professional technologies, and focus on improvement of service professionalism and quality of service.

In some embodiments, the temporary identity credential is generated by the authentication requester based on trusted identity information of a to-be-authenticated user, for example, a name and an identity card or a passport number of the user. In some more specific embodiments, the temporary identity credential can be represented by a cookie, and includes at least an identity user_id of the user to mark user identity information in the authentication requester. The trusted identity information of the user can be obtained by performing real-name authentication in advance, or can be directly obtained as an account required for logging in to an App.

The authentication executor is usually a vendor. After receiving the initialization request of the authentication requester, the authentication executor delivers the session identifier to mark user identity information in the authentication executor, for example, a name and an identity card or a passport number of a user. In some more specific embodiments, the session identifier can be represented by a session_id. The authentication executor establishes the mapping relationship between the received temporary identity credential and the session identifier, stores the mapping relationship in a local cache, undertakes responsibility for maintaining the association between the temporary identity credential and the session identifier, and helps the authentication requester actively detect existence of a risk.

102: Receive a face authentication request initiated by the authentication requester based on the session identifier, and obtain a face authentication result corresponding to the session identifier.

In some embodiments, the authentication executor receives a face authentication link initiated by the authentication requester based on the session identifier, and collects a face image by using the face authentication link; and performs face authentication based on the collected face image to obtain the face authentication result corresponding to the session identifier.

In some more specific embodiments, the face authentication link can be represented by a certify_url. The certify_url is generated based on the session identifier session_id and is received by the authentication executor together with the temporary identity credential cookie, and is used to evoke a face authentication interface in an App, to instruct a user to complete face scanning. The face authentication link is communicated by using the App, is transmitted from the merchant server in the authentication requester to the merchant App, and then is sent to a vendor App in the authentication executor to evoke a face authentication function, and enter a face collection interface. After a user performs authorization, face scanning is completed by using a camera on a terminal device to collect a face image of a to-be-authenticated user, and the collected face image is put in a local face information database to be compared with a corresponding user face image to obtain a face authentication result.

When a user performs, for the first time, an operation such as payment or account login that requires face authentication, the user needs to first set face information to establish an association between user identity information and the face information, and stores the association in the face information database in the local cache for subsequent retrieval.

In some more specific embodiments, the obtaining a face authentication result corresponding to the session identifier includes the following steps: receiving the face authentication request initiated by the authentication requester based on the session identifier and the temporary identity credential corresponding to the session identifier; and obtaining the trusted identity information of the to-be-authenticated user based on the temporary identity credential, and querying a face information database based on the trusted identity information, to obtain the face authentication result corresponding to the session identifier.

The trusted identity information of the user can include a name and an identity card or a passport number of the user. The authentication executor retrieves a corresponding face image from the local face information database based on the trusted identity information, compares the corresponding face image with a user face image collected by the terminal device to obtain a corresponding face authentication result, where the obtained face authentication result is backhauled with the session identifier to the authentication requester. In some more specific embodiments, face image comparison can be performed by using an image similarity detection algorithm in a related technology.

104: Receive an authentication result query request sent by the authentication requester, where the query request includes the session identifier and the temporary identity credential.

In some embodiments, the receiving an authentication result query request sent by the authentication requester includes the following steps: obtaining the face authentication result corresponding to the session identifier, and sending an authentication receipt to the authentication requester, where the authentication receipt includes the session identifier, and the authentication receipt is used to indicate that face authentication corresponding to the session identifier is completed; and when the authentication requester verifies that the session identifier is in correspondence with the temporary identity credential, receiving the authentication result query request sent by the authentication requester.

By verifying whether the session identifier is in correspondence with the temporary identity credential, it can be preliminarily determined whether the face authentication result corresponds to the to-be-authenticated user.

106: Verify, based on the mapping relationship, whether the session identifier matches the temporary identity credential, and return the face authentication result corresponding to the session identifier when the session identifier matches the temporary identity credential.

The vendor server of the authentication executor has a stronger technical capability and stronger security. A task of maintaining and detecting the association between the session identifier and the temporary identity credential is put into the vendor server, so that a risk of an injected attack can be automatically identified when a face authentication query request from the merchant server is processed, to prevent an attacker from bypassing a face authentication step by using a session identifier obtained in advance through face scanning, thereby strengthening an existing face authentication service. Because the vendor undertakes the task of association security detection, operation and maintenance costs and security requirements of the merchant are reduced accordingly, and a fault tolerance rate is increased. This helps the merchant devote more resources to optimization of service content of the merchant.

In this embodiment of this specification, the mapping relationship between the temporary identity credential and the session identifier is maintained and detected, so that the vendor can actively detects user identity security, to prevent a potential client traffic tampering attack, and identify, in a timely manner, a risk of skipping a face detection step by an attacker to steal user information, while reducing access costs of the authentication requester, thereby increasing a fault tolerance rate and a security level of a face authentication service. In addition, because the query authentication result returned to the authentication requester includes the user identity information, the merchant server can perform secondary verification, and has a certain self-security detection capability.

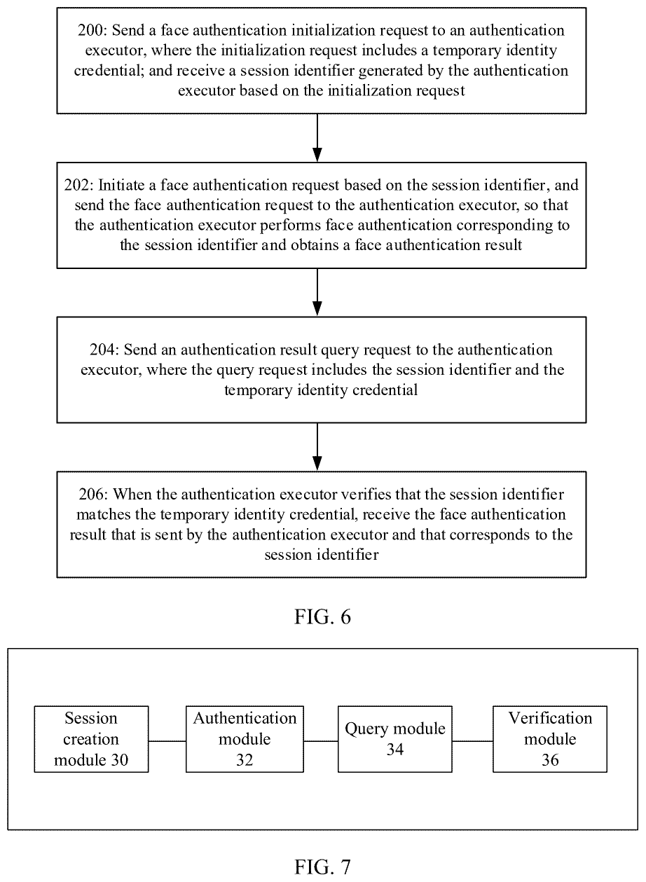

In another embodiment of this specification, a face authentication method is provided. FIG. 6 is an example schematic flowchart illustrating a face authentication method in another implementation, according to an embodiment of this specification.

As shown in FIG. 6, the method is applied to an authentication requester, and the method includes step 200 to step 206.

200: Send a face authentication initialization request to an authentication executor, where the initialization request includes a temporary identity credential; and receive a session identifier generated by the authentication executor based on the initialization request.

The authentication requester is usually an external merchant, including a merchant App and a corresponding merchant server, where the merchant App can be a small program, a mobile-end web page, or a local App. In some specific embodiments, before the face authentication initialization request is sent to the authentication executor, a user first initiates, by using a merchant App on a terminal device, an operation that requires face authentication, such as payment or account login, and generates the face authentication initialization request and sends the face authentication initialization request to a merchant server.

In some embodiments, before the face authentication initialization request is sent to the authentication executor, the face authentication initialization request is generated, and the temporary identity credential, for example, a name and an identity card or a passport number of a user, is generated based on trusted identity information of a to-be-authenticated user. In some more specific embodiments, the temporary identity credential can be represented by a cookie, and includes at least an identity user_id of the user to mark user identity information in the authentication requester. The trusted identity information of the user can be obtained by performing real-name authentication in advance, or can be directly obtained as an account required for logging in to an App.

The authentication executor is usually a vendor, and the authentication executor delivers the session identifier after receiving the initialization request of the authentication requester to mark user identity information in the authentication executor. In some more specific embodiments, the session identifier can be represented by a session_id. The authentication executor establishes a mapping relationship between the received temporary identity credential and the session identifier, stores the mapping relationship in a local cache, undertakes responsibility for maintaining the association between the temporary identity credential and the session identifier, and helps the authentication requester actively detect existence of a risk, thereby reducing access costs and a security detection requirement of the authentication requester.

202: Initiate a face authentication request based on the session identifier, and send the face authentication request to the authentication executor, so that the authentication executor performs face authentication corresponding to the session identifier and obtains a face authentication result.

In some embodiments, a face authentication link is initiated based on the session identifier and is sent to the authentication executor, so that the authentication executor collects a face image by using the face authentication link, and performs face authentication based on the collected face image to obtain the face authentication result corresponding to the session identifier.

In some more specific embodiments, the face authentication link can be represented by a certify_url. The certify_url is generated based on the session identifier session_id and is received by the authentication executor together with the temporary identity credential cookie, and is used to evoke a face authentication interface in an App, to instruct a user to complete face scanning. The face authentication link is communicated by using the App, is transmitted from the merchant server in the authentication requester to the merchant App, and then is sent to a vendor App in the authentication executor to evoke a face authentication function, and enter a face collection interface. After a user performs authorization, face scanning is completed by using a camera on a terminal device to collect a face image of a to-be-authenticated user, and the collected face image is put in a local face information database to be compared with a corresponding user face image to obtain a face authentication result. The face authentication result corresponding to the session identifier is backhauled.

204: Send an authentication result query request to the authentication executor, where the query request includes the session identifier and the temporary identity credential.

In some more specific embodiments, before the sending an authentication result query request to the authentication executor, the following steps are further performed: storing the session identifier and the temporary identity credential in correspondence; receiving an authentication receipt sent by the authentication executor, where the authentication receipt includes the session identifier, and the authentication receipt is used to indicate that face authentication corresponding to the session identifier is completed; and performing matching verification based on the session identifier in the authentication receipt and the temporary identity credential, and sending the authentication result query request to the authentication executor when the session identifier is in correspondence with the temporary identity credential.

By verifying whether the session identifier is in correspondence with the temporary identity credential, it can be preliminarily determined whether the face authentication result corresponds to the to-be-authenticated target user.

206: When the authentication executor verifies that the session identifier matches the temporary identity credential, receive the face authentication result that is sent by the authentication executor and that corresponds to the session identifier.

Because the vendor undertakes the task of maintaining and detecting the association between the session identifier and the temporary identity credential, operation and maintenance costs and security requirements of the merchant are reduced accordingly, and a fault tolerance rate is increased. This helps the merchant devote more resources to optimization of service content of the merchant.

Optionally, when returning the face authentication result corresponding to the session identifier, the authentication executor also returns corresponding user identity information. The merchant server in the authentication requester performs secondary verification based on the returned user identity information to verify an association between the user identity information and target user identity information, and returns the face authentication result when the verification succeeds. As such, the merchant server in the authentication requester also has a capability of self-security detection.

In still another embodiment of this specification, a face authentication apparatus is provided. FIG. 7 is an example schematic structural diagram illustrating a face authentication apparatus in an implementation, according to an embodiment of this specification.

As shown in FIG. 7, the apparatus includes a session creation module, an authentication module, a query module, and a verification module. The session creation module 30 is configured to: receive a face authentication initialization request sent by an authentication requester, where the initialization request includes a temporary identity credential, return a session identifier to the authentication requester, and establish a mapping relationship between the temporary identity credential and the session identifier. The authentication module 32 is configured to: receive a face authentication request initiated by the authentication requester based on the session identifier, and obtain a face authentication result corresponding to the session identifier. The query module 34 is configured to receive an authentication result query request sent by the authentication requester, where the query request includes the session identifier and the temporary identity credential. The verification module 36 is configured to: verify, based on the mapping relationship, whether the session identifier matches the temporary identity credential, and return the face authentication result corresponding to the session identifier when the session identifier matches the temporary identity credential.

In some embodiments, the temporary identity credential is generated by the session creation module based on trusted identity information of a to-be-authenticated user, for example, a name and an identity card or a passport number of the user. In some more specific embodiments, the temporary identity credential can be represented by a cookie, and includes at least an identity user_id of the user to mark user identity information in the authentication requester. The trusted identity information of the user can be obtained by performing real-name authentication in advance, or can be directly obtained as an account required for logging in to an App.

After receiving the initialization request of the authentication requester, the session creation module delivers the session identifier to mark user identity information in an authentication executor, for example, a name and an identity card or a passport number of a user. In some more specific embodiments, the session identifier can be represented by a session_id. The session creation module establishes the mapping relationship between the received temporary identity credential and the session identifier, stores the mapping relationship in a local cache, undertakes responsibility for maintaining the association between the temporary identity credential and the session identifier, and helps the authentication requester actively detect existence of a risk.

In some embodiments, the authentication module receives a face authentication link initiated by the authentication requester based on the session identifier, and collects a face image by using the face authentication link; and performs face authentication based on the collected face image to obtain the face authentication result corresponding to the session identifier.

The face authentication link is used to evoke a face authentication function in an App, and enter a user face collection interface. After a user performs authorization, face scanning is completed by using a camera on a terminal device to collect a face image of a to-be-authenticated user, and the collected face image is put in a local face information database to be compared with a corresponding user face image to obtain a face authentication result.

In some more specific embodiments, that the authentication module obtains the face authentication result corresponding to the session identifier includes the following steps:
receiving the face authentication request initiated by the authentication requester based on the session identifier and the temporary identity credential corresponding to the session identifier;
and obtaining the trusted identity information of the to-be-authenticated user based on the temporary identity credential, and querying a face information database based on the trusted identity information, to obtain the face authentication result corresponding to the session identifier.

The trusted identity information of the user can include a name and an identity card or a passport number of the user. The authentication module retrieves a corresponding face image from the local face information database based on the trusted identity information, compares the corresponding face image with a user face image collected by the terminal device to obtain a corresponding face authentication result, where the obtained face authentication result is backhauled with the session identifier. In some more specific embodiments, face image comparison can be performed by using an image similarity detection algorithm in a related technology.

In some embodiments, that the query module receives the authentication result query request sent by the authentication requester includes the following steps: obtaining the face authentication result corresponding to the session identifier, and sending an authentication receipt to the authentication requester, where the authentication receipt includes the session identifier, and the authentication receipt is used to indicate that face authentication corresponding to the session identifier is completed; and when the authentication requester verifies that the session identifier is in correspondence with the temporary identity credential, receiving the authentication result query request sent by the authentication requester.

By verifying whether the session identifier is in correspondence with the temporary identity credential, it can be preliminarily determined whether the face authentication result corresponds to the to-be-authenticated user.

Optionally, when returning the face authentication result corresponding to the session identifier, the verification module also returns corresponding user identity information, performs secondary verification based on user identity information returned by the query module to verify an association between the user identity information and target user identity information, and returns the face authentication result when the verification succeeds. As such, the authentication requester also has a capability of self-security detection.

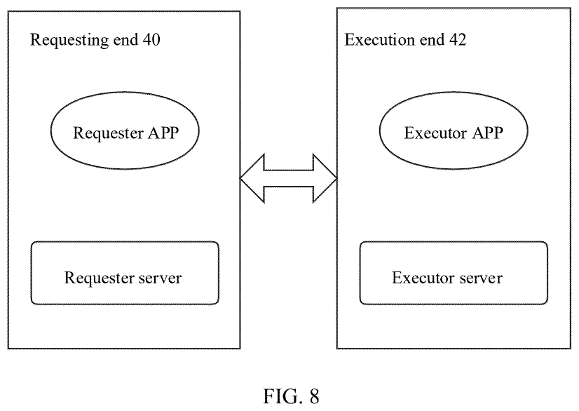

In still another embodiment of this specification, a face authentication system is provided. FIG. 8 is an example schematic structural diagram illustrating a face authentication system in an implementation, according to an embodiment of this specification.

As shown in FIG. 8, the system includes a requesting end 40 and an execution end 42. The requesting end sends a face authentication initialization request to the execution end, where the initialization request includes a temporary identity credential. The execution end returns a session identifier to the requesting end, and establishes a mapping relationship between the temporary identity credential and the session identifier. The requesting end initiates a face authentication request based on the session identifier, and sends the face authentication request to the execution end, and the execution end obtains a face authentication result corresponding to the session identifier. The requesting end sends an authentication result query request to the execution end, where the query request includes the session identifier and the temporary identity credential. The execution end verifies, based on the mapping relationship, whether the session identifier matches the temporary identity credential, and returns the face authentication result corresponding to the session identifier when the session identifier matches the temporary identity credential.

The requesting end is usually an external merchant, including a merchant App and a corresponding merchant server, where the merchant App can be a small program, a mobile-end web page, or a local App. In a case of limited technologies or costs, some merchant developers usually select three-party services provided by some large mobile applications (or referred to as vendors), which not only can reduce operation and maintenance costs and improve service efficiency, but also can make up for gaps in professional technologies, and focus on improvement of service professionalism and quality of service.

The execution end is usually the above-mentioned vendor, which has a perfect professional technical department to provide specific technical services.

In some embodiments, the requesting end is further configured to: generate the face authentication initialization request, generate the temporary identity credential based on trusted identity information of a to-be-authenticated user, and attach the temporary identity credential to the face authentication initialization request to be sent to the execution end.

The trusted identity information of the user can include a name and an identity card or a passport number of the user. In some more specific embodiments, the temporary identity credential can be represented by a cookie, and includes at least an identity user_id of the user to mark user identity information in the authentication requester. The trusted identity information of the user can be obtained by performing real-name authentication in advance, or can be directly obtained as an account required for logging in to an App.

In some more specific embodiments, the session identifier can be represented by a session id. The execution end establishes the mapping relationship between the received temporary identity credential and the session identifier, stores the mapping relationship in a local cache, undertakes responsibility for maintaining the association between the temporary identity credential and the session identifier, and helps the requesting end actively detect existence of a risk.

In some embodiments, the requesting end initiates a face authentication link based on the session identifier, and sends the face authentication link to the execution end, so that the execution end collects a face image by using the face authentication link, and performs face authentication based on the collected face image to obtain the face authentication result corresponding to the session identifier.

In some more specific embodiments, the face authentication link can be represented by a certify_url. The certify_url is generated based on the session identifier session_id and is received by the execution end together with the temporary identity credential cookie, and is used to evoke a face authentication interface in an App, to instruct a user to complete face scanning. The face authentication link is communicated by using the App, is transmitted from the merchant server at the requesting end to the merchant App, and then is sent to a vendor App at the execution end to evoke a face authentication function, and enter a face collection interface. After a user performs authorization, face scanning is completed by using a camera on a terminal device to collect a face image of a to-be-authenticated user, and the collected face image is put in a local face information database at the execution end to be compared with a corresponding user face image to obtain a face authentication result.

When a user performs, for the first time, an operation such as payment or account login that requires face authentication, the user needs to first set face information to establish an association between user identity information and the face information, and stores the association in the face information database in the local cache at the execution end for subsequent retrieval.

In some more specific embodiments, the requesting end is further configured to:
initiate the face authentication request based on the session identifier, and send the face authentication request and the temporary identity credential corresponding to the session identifier to the execution end, so that the execution end obtains the trusted identity information of the to-be-authenticated user based on the temporary identity credential, and queries a face information database based on the trusted identity information, to obtain the face authentication result corresponding to the session identifier.

The trusted identity information of the user can include a name and an identity card or a passport number of the user. The execution end retrieves a corresponding face image from the local face information database based on the trusted identity information, compares the corresponding face image with a user face image collected by the terminal device to obtain a corresponding face authentication result, where the obtained face authentication result is backhauled with the session identifier to the requesting end. In some more specific embodiments, face image comparison can be performed by using an image similarity detection algorithm in a related technology.

In some embodiments, the requesting end is further configured to store the session identifier and the temporary identity credential in correspondence; the execution end obtains the face authentication result corresponding to the session identifier, and sends an authentication receipt to the requesting end, where the authentication receipt includes the session identifier, and the authentication receipt is used to indicate that face authentication corresponding to the session identifier is completed; and the requesting end performs matching verification based on the session identifier in the authentication receipt and the temporary identity credential, and sends the authentication result query request to the execution end when the session identifier is in correspondence with the temporary identity credential.

Optionally, when returning the face authentication result corresponding to the session identifier, the execution end also returns corresponding user identity information. The requesting end performs secondary verification based on the returned user identity information to verify an association between the user identity information and target user identity information, and returns the face authentication result when the verification succeeds. As such, the requesting end also has a capability of self-security detection.

In an embodiment of this specification, a computer-readable storage medium is further provided. The storage medium stores a computer program, and when the computer program is executed by a processor, the steps in the above-mentioned face authentication method are implemented.

In an embodiment of this specification, an electronic device is further provided, including a memory, a processor, and a computer program that is stored in the memory and that is capable of running on the processor. When the processor executes the program, the steps in the above-mentioned face authentication method are implemented.

Specific embodiments of this specification are described above. Other embodiments fall within the scope of the appended claims. In some cases, actions or steps described in the claims can be performed in an order different from that in the embodiments and desired results can still be achieved. In addition, the processes depicted in the accompanying drawings do not necessarily need a specific order or a sequential order to achieve the desired results. In some implementations, multi-tasking and parallel processing are feasible or may be advantageous.

It is worthwhile to note that the above-mentioned examples are merely specific embodiments of this specification. Clearly, this specification is not limited to the above-mentioned embodiments, and has many similar variations accordingly. All variations directly derived or associated by a person skilled in the art from the content disclosed in this specification shall fall within the protection scope of this specification.

1. A face authentication method, wherein the method comprises:
receiving a face authentication initialization request sent by an authentication requester, wherein the initialization request comprises a temporary identity credential; returning a session identifier to the authentication requester; and establishing a mapping relationship between the temporary identity credential and the session identifier;
receiving a face authentication request initiated by the authentication requester based on the session identifier, and obtaining a face authentication result corresponding to the session identifier;
receiving an authentication result query request sent by the authentication requester, wherein the query request comprises the session identifier and the temporary identity credential;
and
verifying, based on the mapping relationship, whether the session identifier matches the temporary identity credential, and returning the face authentication result corresponding to the session identifier when the session identifier matches the temporary identity credential.

2. The method according to claim 1, wherein the step of receiving a face authentication request initiated by the authentication requester based on the session identifier, and obtaining a face authentication result corresponding to the session identifier comprises:
receiving a face authentication link initiated by the authentication requester based on the session identifier, and collecting a face image by using the face authentication link; and
performing face authentication based on the collected face image to obtain the face authentication result corresponding to the session identifier.

3. The method according to claim 1, wherein the temporary identity credential is generated by the authentication requester based on trusted identity information of a to-be-authenticated user.

4. The method according to claim 3, wherein the step of obtaining a face authentication result corresponding to the session identifier comprises:
receiving the face authentication request initiated by the authentication requester based on the session identifier and the temporary identity credential corresponding to the session identifier; and
obtaining the trusted identity information of the to-be-authenticated user based on the temporary identity credential, and querying a face information database based on the trusted identity information, to obtain the face authentication result corresponding to the session identifier.

5. The method according to claim 1, wherein the step of receiving a face authentication request initiated by the authentication requester based on the session identifier, obtaining a face authentication result corresponding to the session identifier, and receiving an authentication result query request sent by the authentication requester comprises:
obtaining the face authentication result corresponding to the session identifier, and sending an authentication receipt to the authentication requester, wherein the authentication receipt comprises the session identifier, and the authentication receipt is used to indicate that face authentication corresponding to the session identifier is completed; and
when the authentication requester verifies that the session identifier is in correspondence with the temporary identity credential, receiving the authentication result query request sent by the authentication requester.

6-15. (canceled)

16. A non-transitory computer-readable storage medium, wherein the non-transitory computer-readable storage medium stores a computer program, and when the computer program is executed by a processor causes the processor to:
receive a face authentication initialization request sent by an authentication requester, wherein the initialization request comprises a temporary identity credential; return a session identifier to the authentication requester; and establish a mapping relationship between the temporary identity credential and the session identifier;
receive a face authentication request initiated by the authentication requester based on the session identifier, and obtain a face authentication result correspond to the session identifier;
receive an authentication result query request sent by the authentication requester, wherein the query request comprises the session identifier and the temporary identity credential; and
verify based on the mapping relationship, whether the session identifier matches the temporary identity credential, and return the face authentication result corresponding to the session identifier when the session identifier matches the temporary identity credential;

17. (canceled)

18. The non-transitory computer-readable storage medium according to claim 16, wherein the processor being caused to receive a face authentication request initiated by the authentication requester based on the session identifier, and obtain a face authentication result corresponding to the session identifier comprises being caused to:
receive a face authentication link initiated by the authentication requester based on the session identifier, and collect a face image by using the face authentication link; and
perform face authentication based on the collected face image to obtain the face authentication result corresponding to the session identifier.

19. The non-transitory computer-readable storage medium according to claim 16, wherein the temporary identity credential is generated by the authentication requester based on trusted identity information of a to-be-authenticated user.

20. The non-transitory computer-readable storage medium according to claim 19, wherein the processor being caused to obtain a face authentication result corresponding to the session identifier comprises being caused to:
receive the face authentication request initiated by the authentication requester based on the session identifier and the temporary identity credential corresponding to the session identifier; and
obtain the trusted identity information of the to-be-authenticated user based on the temporary identity credential, and query a face information database based on the trusted identity information, to obtain the face authentication result corresponding to the session identifier.

21. The non-transitory computer-readable storage medium according to claim 16, wherein the processor being caused to receive a face authentication request initiated by the authentication requester based on the session identifier, obtain a face authentication result corresponding to the session identifier, and receive an authentication result query request sent by the authentication requester comprises being caused to:
obtain the face authentication result corresponding to the session identifier, and send an authentication receipt to the authentication requester, wherein the authentication receipt comprises the session identifier, and the authentication receipt is used to indicate that face authentication corresponding to the session identifier is completed; and
when the authentication requester verifies that the session identifier is in correspondence with the temporary identity credential, receive the authentication result query request sent by the authentication requester.

22. An electronic device, comprising a memory, a processor, and a computer program that is stored in the memory and that is capable of running on the processor, wherein when the processor executes the program, the electronic device is caused to:
receive a face authentication initialization request sent by an authentication requester, wherein the initialization request comprises a temporary identity credential; return a session identifier to the authentication requester; and establish a mapping relationship between the temporary identity credential and the session identifier;
receive a face authentication request initiated by the authentication requester based on the session identifier, and obtain a face authentication result correspond to the session identifier;
receive an authentication result query request sent by the authentication requester, wherein the query request comprises the session identifier and the temporary identity credential; and
verify based on the mapping relationship, whether the session identifier matches the temporary identity credential, and return the face authentication result corresponding to the session identifier when the session identifier matches the temporary identity credential;

23. The electronic device according to claim 22, wherein the processor being caused to receive a face authentication request initiated by the authentication requester based on the session identifier, and obtain a face authentication result corresponding to the session identifier comprises being caused to:
receive a face authentication link initiated by the authentication requester based on the session identifier, and collect a face image by using the face authentication link; and
perform face authentication based on the collected face image to obtain the face authentication result corresponding to the session identifier.

24. The electronic device according to claim 22, wherein the temporary identity credential is generated by the authentication requester based on trusted identity information of a to-be-authenticated user.

25. The electronic device according to claim 24, wherein the processor being caused to obtain a face authentication result corresponding to the session identifier comprises being caused to:
receive the face authentication request initiated by the authentication requester based on the session identifier and the temporary identity credential corresponding to the session identifier; and
obtain the trusted identity information of the to-be-authenticated user based on the temporary identity credential, and query a face information database based on the trusted identity information, to obtain the face authentication result corresponding to the session identifier.

26. The electronic device according to claim 22, wherein the processor being caused to receive a face authentication request initiated by the authentication requester based on the session identifier, obtain a face authentication result corresponding to the session identifier, and receive an authentication result query request sent by the authentication requester comprises being caused to:
obtain the face authentication result corresponding to the session identifier, and send an authentication receipt to the authentication requester, wherein the authentication receipt comprises the session identifier, and the authentication receipt is used to indicate that face authentication corresponding to the session identifier is completed; and
when the authentication requester verifies that the session identifier is in correspondence with the temporary identity credential, receive the authentication result query request sent by the authentication requester.
